(19) United States
(12) Patent Application Publication
(10) Pub. No.: US 2010/0232274 A1
(43) Pub. Date: Sep. 16, 2010

(54) METHOD AND APPARATUS FOR DETECTING DISC

(76) Inventors: Ping-Tsai Tsai, Kaohsiung City (TW); Chih-Tien Chen, Taipei City (TW); Ya-Fang Nien, Hsin-Chu City (TW); Sung-Yang Wu, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/402,509

(22) Filed: Mar. 12, 2009

(51) Int. Cl. G11B 27/36

(52) U.S. Cl. 369/53.2; G9B/27.052

(57) ABSTRACT

A method for detecting a disc, the method includes the steps of: reading a file system of the disc; determining a type of the disc according to the file system; and abandoning a multi-session checking process upon the disc if the type of the disc is a one-session disc.

### BACKGROUND OF THE INVENTION

The present invention relates to method and apparatus for detecting a disc, and more particularly, to a method and an apparatus for detecting the disc according to a file system on the disc.

A multi-session recording is widely used in different types of recordable discs (e.g. a DVD+R disc or a DVD-R disc), which allows an user to record data on a single disc several times so as to form several session containing data on the disc. This kind of disc is usually called as a multi-session disc. For a logical unit (e.g. a DVD-ROM drive or a DVD player), it is more complicated to recognize the multi-session disc and read data thereon.

Please refer to FIG. 1, which is a diagram illustrating a conventional method for recognizing a multi-session recorded disc. As shown in FIG. 1, a multi-session disc 100 contains a session A and a session B. Session A has a lead-in area 120, a data area 130, and a border-out area 130. Session B has a border-in area 140, a data area 150, and a border-out area 160. If the multi-session disc 100 is inserted into a disc player (not shown), the steps of detection performed by the disc player are explained as follows. First of all, the disc player reads physical format information on lead-in area 120, checking start address of border-out area 130 and checking start address of border-in area 140. Then, the disc player reads next border marker in border-out area 130 indicating whether a next session exists or not and find the next session. Accordingly, the disc player reads physical format information on border-in area 140, checking start address of border-out area 160 and checking whether the session B is followed by a more session. After the disc player finishes the recognition of all session on the multi-session disc 100, a host (not shown) will issue a READ command to read data recorded on the data areas of the multi-session disc 100. Normally, it takes quite a long time to finish the recognition of all sessions on the multi-session disc 100.

However, as for DVD-Video discs, DVD-VR discs, and DVD+VR discs, they generally have only one session. Besides, data recorded on these discs usually occupies the whole volume of discs, which means that if the multi-session checking procedure performed on these discs, it will make the pick-up head of the disc player move onto the outer zone of the disc, which is technically not necessary, and thereby prolonging the time to determine the disc.

### SUMMARY OF THE INVENTION

One of the objectives of the present invention is therefore to provide a method and an apparatus for detecting whether a disc is one-session disc or not according to a file system on the disc.

For a DVD-Video disc (as well as a DVD-VR disc or a DVD+VR disc), it only contains a single session (border) in general, so the multi-session detection for the DVD-Video disc is unnecessary. Besides, since the first directory on the DVD-Video disc must be the “VIDEO_TS” directory containing all the video files, the present invention utilizes this feature of the DVD-Video disc, checking the file system of an inserted DVD disc rather than detecting each session on the inserted DVD disc from the Lead-In area (at the start of the disc) to the Lead-out area (at the end of the disc). Thus, the unnecessary multi-session detection for the DVD-Video disc can be omitted so as to reduce the longer time required by the multi-session detection as the DVD-Video disc is almost a single-session disc.

Therefore, according to an embodiment of the present invention, a method for detecting a disc is disclosed. The method comprises the following steps: reading a file system of the disc; determining a type of the disc according to the file system; and abandoning a multi-session checking process upon the disc if the type of the disc is a one-session disc.

According to a second embodiment of the present invention, an apparatus for detecting a disc disclosed. The apparatus comprises a reader, a determining unit, and a controlling unit. The reader is utilized for reading a file system of the disc. The determining unit is coupled to the reader for determining a type of the disc according to the file system. The controlling unit is coupled to the determining unit for abandoning a multi-session checking process upon the disc if the type of the disc is a one-session disc.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is diagram illustrating a conventional method for detecting a multi-session disc.

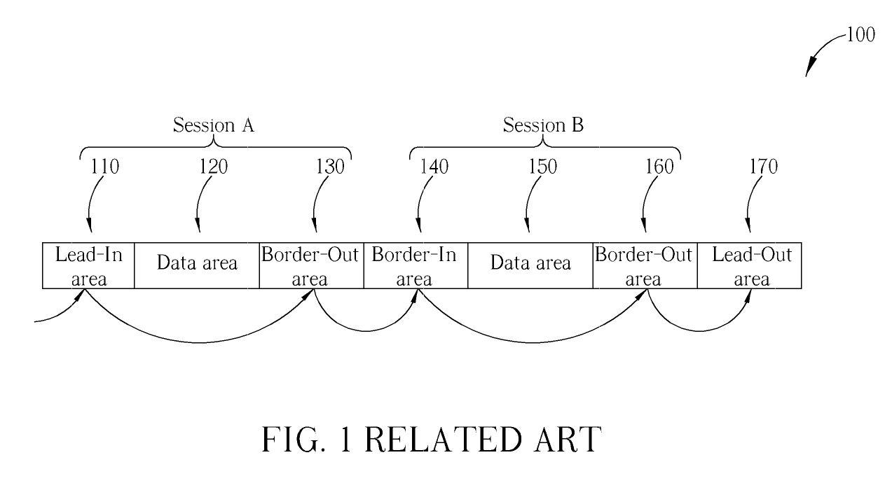

FIG. 2 is a diagram illustrating an apparatus for detecting a disc according to an embodiment of the present invention.

FIG. 3 is a flowchart illustrating a method for detecting a disc according to one exemplary embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ” Also, the term “couple” is intended to mean either an indirect or direct electrical connection. Accordingly, if one device is coupled to another device, that connection may be through a direct electrical connection, or through an indirect electrical connection via other devices and connections.

For each DVD-Video disc, there is always a main directory on the data area, named VIDEO_TS (for Video Title Sets), holds the DVD video files. Besides, an “AUDIO_TS” directory for DVD audio also exists on the DVD-Video disc. The VIDEO_TS directory usually contains three types of files with the following extensions: IFO, containing navigation data (it corresponds to the Video Manager); VOB (Video Object Block), containing video streams; the audio channels and the subtitles for a video title. BUP (BUP stands for Backup), which contains a backup of the IFO files, in case they become unreadable. Therefore, the present invention utilizes this feature of a DVD-Video disc, read a file system on a disc to check whether there is a particular file (e.g. a VIDEO_TS.IFO file, a VIDEO_RM.IFO file, an AUDIO_TS.IFO file, a VR_MANGR.IFO file, a VOB file, or a BUP file) or folder (e.g. a VIDEO_TS folder, a 2C_AUDIO folder, or an AUDIO_TS folder) corresponding to a video format (e.g. DVD-Video) in the file system in order to determine whether the disc is a video disc. If the disc is a video disc, which means that the disc may be a one-session disc, then a multi-session checking process is abandoned. If the disc is not a video disc, which means that the disc may be a multi-session disc, then the multi-session checking process will be further performed for the disc. As a result, the unnecessary multi-session detection for the video disc can be avoided so as to save a determination time for the disc when the disc is loaded.

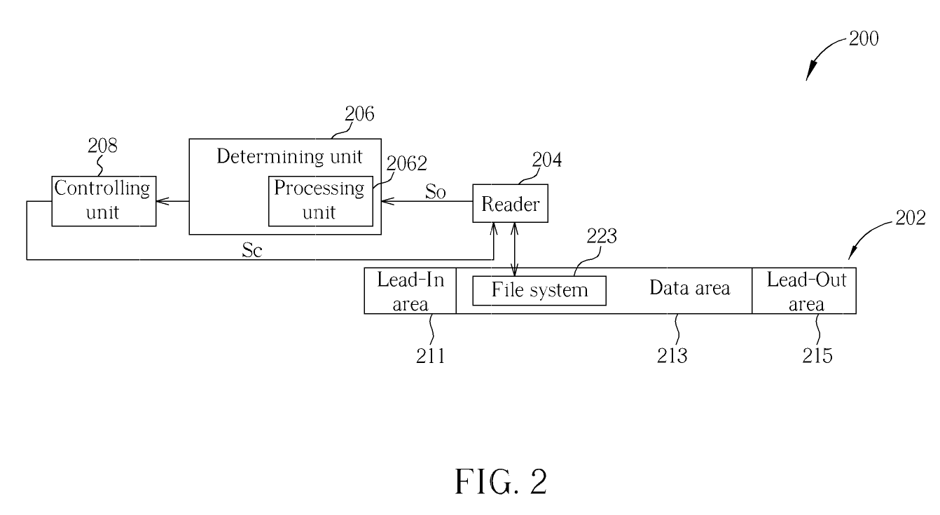

Please refer to FIG. 2. FIG. 2 is a diagram illustrating an apparatus 200 for detecting a disc 202 according to an embodiment of the present invention. The apparatus 200 comprises a reader 204, a determining unit 206, and a controlling unit 208. The reader 204 is utilized for reading a file system 223 of the disc 202. The determining unit 206 is coupled to the reader 204 for determining a type of the disc according to the file system 223. The controlling unit 208 is coupled to the determining unit 206 and the reader 204 for abandoning a multi-session checking process upon the disc 202 if the type of the disc 202 is a one-session disc, and performing the multi-session checking process upon the disc 202 if the type of the disc 202 is a multi-session disc. In addition, the disc 202 comprises a session 210 having a lead-in area 211, a data area 213, and a lead-out area 215. According to the embodiment of the present invention, when the disc 202 is loaded into a disc player, the reader 204 reads the physical format information saved in the lead-in area 211 firstly, in which the physical format information relates to the information of the category of the disc 202, such as a DVD-R disc or a DVD+R disc, and the starting address of the data area 213, wherein the file system 223 may be saved at the position of the starting address of the data area 213. Therefore, when the starting address of the data area 213 is read by the reader 204, the reader 204 is moved to the starting address of the data area 213 to read the file system 223.

Then, the reader 204 outputs an output result So to the determining unit 206, the processing unit 2062 in the determining unit 206 receives the output result So to check if any specific content existed in the file system 223 to determine the type of the disc 202. If any folder named VIDEO_TS, AUDIO_TS, or 2C_AUDIO, or any file named VIDEO_TS.IFO, VIDEO_RM.IFO, AUDIO_TS.IFO, or VR_MANGR.IFO existed in the file system 223, the determining unit 206 determines the type of the disc 202 as a video disc type. According to the embodiment of the present invention, the video disc type may be a DVD-Video (Digital Versatile Disc-Video), DVD-VR (Digital Versatile Disc-Video Recording), or DVD+VR (Digital Versatile Disc+Video Recording). In addition, since most of the video disc type is a one-session disc, i.e., the disc using only one session, the controlling unit 208 outputs a control signal Sc to the reader 204 to abandon a multi-session checking process upon the disc 202 and end the loading procedure of the disc 202 when determining unit 206 determines the type of the disc 202 as a video disc type. On the contrary, the controlling unit 208 outputs the control signal Sc to the reader 204 to perform the multi-session checking process upon the disc 202 when determining unit 206 determines that the type of the disc 202 is not the video disc type. Therefore, according to the embodiment of the present invention, the time used for performing the multi-session checking process can be saved when the disc 202 belongs to the video disc type, this is because the video disc is the one-session disc and there is no need for detecting whether there is more session on the video disc.

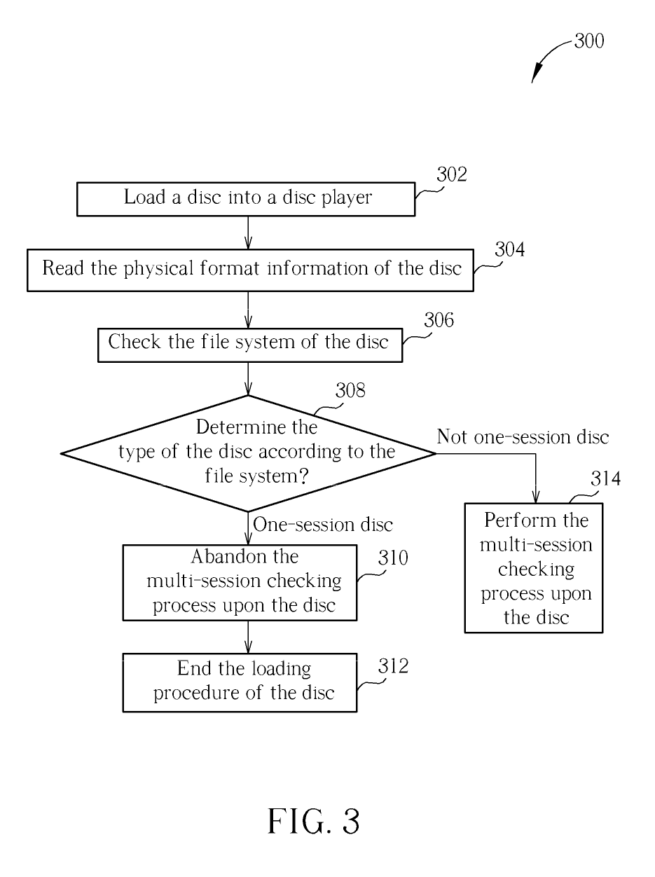

Please refer to FIG. 3. FIG. 3 is a flowchart illustrating a method 300 for detecting a disc according to one exemplary embodiment of the present invention. Provided that substantially the same result is achieved, the steps of the flowchart shown in FIG. 3 need not be in the exact order shown and need not be contiguous, that is, other steps can be intermediate. In addition, the method 300 may be implemented by the apparatus 200 as shown in FIG. 2. Therefore, the following disclosure relates the method 300 is described in conjunction with the apparatus 200 for brevity. The method 300 comprises the following steps:

Step 302: Load the disc 202 into the disc player;

Step 304: Read the physical format information of the disc 202;

Step 306: Check the file system 223 of the disc 202;

Step 308: Determine the type of the disc 202 according to the file system 223, if the disc 202 is the one-session disc, go to step 310, if the disc 202 is not the one-session disc, go to step 314;

Step 310: Abandon the multi-session checking process upon the disc 202;

Step 312: End the loading procedure of the disc 202;

Step 314: Perform the multi-session checking process upon the disc 202.

Firstly, the disc 202 including at least one session composed of a lead-in area 211, a data area 213, a lead-out area 215 is loaded in step 302. Then, the physical format information which contains the category of the disc 202 (a DVD-R disc or a DVD+R disc) and the starting address of the data area 213 recorded on the lead-in area 311 is read in step 304. According to the starting address of the data area 213 indicated by the physical format information, the file system 223 can be accessed by the reader 204 in step 306. In step 308, the present method 300 checks if any specific content existed in the file system 223 to determine if the disc 202 is the one-session disc or not. If any folder named VIDEO_TS, AUDIO_TS, or 2C_AUDIO, or any file named VIDEO_TS.IFO, VIDEO_RM.IFO, AUDIO_TS.IFO, or VR_MANGR.IFO existed in the file system 223, the type of the disc 202 is determined as the video disc type, i.e., the one-session disc. According to the embodiment of the present invention, the video disc type may be a DVD-Video (Digital Versatile Disc-Video), DVD-VR (Digital Versatile Disc-Video Recording), or DVD+VR (Digital Versatile Disc+Video Recording). It should be noted that most of the video disc type is the one-session disc, i.e., the disc using only one session. Then, the multi-session checking process upon the disc 202 is abandoned and ended the loading procedure of the disc 202 when determines that the type of the disc 202 is the video disc type (steps 310 and 312). On the contrary, the multi-session checking process upon the disc 202 is performed determines that the type of the disc 202 is not the video disc type (step 314). Therefore, according to the embodiment of the present invention, the time used for performing the multi-session checking process can be saved when the disc belongs to the video disc type, this is because the video disc is the one-session disc and there is no need for detecting whether there is more session on the video disc.

Briefly, the present invention checks the file system of an inserted DVD disc rather than detects each session on the inserted DVD disc from the Lead-In area (at the start of the disc) to the Lead-out area (at the end of the disc) so as to save time required by the multi-session checking process.

Those skilled in the art will readily observe that numerous modifications and alterations of the device and method may be made while retaining the teachings of the invention.

What is claimed is:

1. A method for detecting a disc, comprising:
reading a file system of the disc;
determining a type of the disc according to the file system; and
abandoning a multi-session checking process upon the disc if the type of the disc is a one-session disc.

2. The method of claim 1, further comprising:
performing the multi-session checking process upon the disc if the type of the disc is a multi-session disc.

3. The method of claim 1, wherein the one-session disc comprises a DVD-Video (Digital Versatile Disc-Video), DVD-VR (Digital Versatile Disc-Video Recording), or DVD+VR (Digital Versatile Disc+Video Recording).

4. The method of claim 1, wherein the step of determining the type of the disc according to the file system comprises:
checking if at least one specific content existed in the file system; and
if the specific content existed in the file system, determining the type of the disc as the video disc type.

5. The method of claim 4, wherein the specific content comprises a folder named as VIDEO_TS, AUDIO_TS, or 2C_AUDIO.

6. The method of claim 4, wherein the specific content comprises a file named as VIDEO_TS.IFO, VIDEO_RM.IFO, AUDIO_TS.IFO, or VR_MANGR.IFO.

7. An apparatus for detecting a disc, comprising:
a reader, for reading a file system of the disc;
a determining unit, coupled to the reader, for determining a type of the disc according to the file system; and
a controlling unit, coupled to the determining unit, for abandoning a multi-session checking process upon the disc if the type of the disc is a one-session disc.

8. The apparatus of claim 7, wherein the controlling unit further performs the multi-session checking process upon the disc if the type of the disc is a multi-session disc.

9. The apparatus of claim 7, wherein the one-session disc comprises a DVD-Video (Digital Versatile Disc-Video), DVD-VR (Digital Versatile Disc-Video Recording), or DVD+VR (Digital Versatile Disc+Video Recording).

10. The apparatus of claim 7, wherein the determining unit comprises:
a processing unit, for checking if at least one specific content existed in the file system, and determining the type of the disc as the video disc type if the specific content existed in the file system.

11. The apparatus of claim 10, wherein the specific content comprises a folder named as VIDEO_TS, AUDIO_TS, or 2C_AUDIO.

12. The apparatus of claim 10, wherein the specific content comprises a file named as VIDEO_TS.IFO, VIDEO_RM.IFO, AUDIO_TS.IFO, or VR_MANGR.IFO.
